(19) United States
(12) Patent Application Publication
(10) Pub. No.: US 2026/0088296 A1
(43) Pub. Date: Mar. 26, 2026

(54) LITHIUM-ION BATTERIES WITH HIGHLY STABLE ELECTRODES

(71) Applicant: Nano and Advanced Materials Institute Limited, Hong Kong (HK)

(72) Inventors: Yong ZHU, Hong Kong (HK); Jianping HAN, Hong Kong (HK); Pao Chieh WANG, Hong Kong (HK); Tze Lok Andy CHAN, Hong Kong (HK); Yingshun LI, Hong Kong (HK); Yangfan ZHOU, Hong Kong (HK); Shengbo LU, Hong Kong (HK); Li FU, Hong Kong (HK); Chenmin LIU, Hong Kong (HK)

(21) Appl. No.: 18/894,017

(22) Filed: Sep. 24, 2024

(51) Int. Cl. H01M 4/62; H01M 4/02; H01M 4/131; H01M 4/505; H01M 4/525; H01M 10/0525; H01M 50/411; H01M 50/491

(52) U.S. Cl. CPC H01M 4/623; H01M 4/131; H01M 4/505; H01M 4/525; H01M 4/625; H01M 10/0525; H01M 50/411; H01M 50/491; H01M 2004/027; H01M 2004/028

(57) ABSTRACT

A lithium-ion battery is provided, including a cathode with one or more nickel-rich ternary cathode materials, specifically LiNiₓMn_{y}Co_{z}O₂ or LiNiₓAl_{y}Co_{z}O₂, where x, y, and z sum to 1 and x is at least 0.8. The battery also includes an anode made from materials such as silicon, silicon oxide, carbon nanotubes, lithium metal, graphene, and graphite, and features a porous polymer separator with a porosity of 30% to 90%. An electrolyte is also included. A key aspect is the use of a gel-free binder, which is a modified polyvinylidene fluoride (PVDF) grafted with monomers containing at least one unsaturated carbon-carbon double bond and functional groups. This modification prevents defluorination and crosslinking of the PVDF when in contact with the nickel-rich cathode materials.

### FIELD OF THE INVENTION

The present invention generally relates to lithium-based batteries. More specifically the present invention relates to lithium-ion batteries with highly stable electrodes.

### BACKGROUND OF THE INVENTION

Recently, due to increasing environmental awareness and the goal of achieving carbon neutrality, rechargeable lithium-ion batteries have come to dominate the energy market, ranging from portable electronic appliances to electric vehicles (EVs). Improving the energy density of lithium-ion batteries is crucial to addressing the range anxiety associated with EVs. Several strategies are being developed to enhance energy density, including replacing graphite with lithium metal as the anode, developing solid-state electrolytes, and using high-nickel-content ternary systems as cathode materials.

The high specific capacity of the lithium metal anode, at 3860 mAh/g, has not been fully realized due to the limited specific capacity of current cathode materials. LiCoO₂, used as a cathode material since the 1980s, has limited applications due to the high cost of cobalt and its relatively low capacity. Replacing cobalt with other transition metals in the layered structure can lead to improved cell performance. For example, Ni-rich Li[NiₓCo_{y}Mn_{z}]O₂ (x+y+z=1) (NCM) or Li[NiₓCo_{y}Al_{z}]O₂ (x+y+z=1) (NCA) offer high capacities and high-voltage operation. The specific capacity (mAh/g) of NCM increases with higher nickel content. Ni-rich NCM ternary cathode materials, such as NCM811 or NCA811, are widely considered excellent candidates for improving the energy density of next-generation lithium metal batteries due to their high reversible capacities.

Polyvinylidene fluoride (PVDF) is one of the most widely used binders in cathodes because of its distinct properties, including high chemical resistance, good thermal stability, excellent processability, and extraordinary mechanical properties. However, when PVDF is used as a binder in Ni-rich cathodes, several issues still need to be addressed.

Firstly, the Ni-rich cathode slurry tends to gel quickly. The common process of fabricating NCM cathodes involves mixing active materials (NCM powders), conductive carbons, and a PVDF binder with a suitable solvent, generally N-methyl pyrrolidinone (NMP), to form a uniform cathode slurry. This slurry is then cast onto aluminum foil and adequately dried. The resultant electrode is subsequently pressed or calendared into the desired porosity and punched into the required shape. However, the high nickel content in layered oxides leads to the presence of LiOH or Li₂CO₃ due to the instability of LiNiO₂. The generation of these LiOH or Li₂CO₃ in Ni-rich cathode materials is a major obstacle hindering their commercialization. One critical effect of these impurities is an increase in the pH of the electrode slurry during mass production, which induces the crosslinking of polyvinylidene fluoride (PVDF) via a dehydrofluorination reaction (FIG. 1) and causes slurry gelation. This makes the electrode casting process uncontrollable on mass production lines because the viscosity of the gel changes in an unpredictable manner.

Some methods have been tried to improve cathode slurry stability. For example, Patent US20210043938A1 introduces oxalic acid into the cathode slurry to improve stability by lowering the pH value. However, oxalic acid itself is an impurity that may cause side effects on battery performance. Patents U.S. Pat. Nos. 9,257,696B2 and 9,343,744B2 use tetrafluoroethene (TFE) and/or hexafluoropropene (HFP) with vinylidene fluoride (VDF) as a monomer to synthesize P(VDF-co-TFE-co-HFP), increasing its resistance to dehydrofluorination by replacing some hydrogen atoms with fluorine atoms, thus improving slurry stability. However, the monomers are harmful, and the synthesis is conducted under high pressure, making the process dangerous. Moreover, the incorporation of TFE and HFP could increase slurry viscosity and decrease binder adhesion.

Secondly, the binding strength of the PVDF binder is insufficient. During the charge and discharge cycles of the battery, cathode materials experience volume shrinkage and expansion, introducing strain fatigue on both electrodes. Therefore, the binding strength between the active materials and the current collector, as well as the flexibility of the electrode, need to be high to achieve a prolonged battery life. PVDF is a semi-crystalline thermoplastic fluoropolymer with low polarity, resulting in insufficient adhesion, especially when used in Ni-rich cathode preparation. Patents US20190252685A1 and WO2008129041A1 incorporate small amounts of acrylic acid (AA) or methacrylic acid (MAA) in PVDF. However, the synthesis is also conducted under high pressure, and the AA or MAA content is too small (<5%) to obtain a satisfactory effect.

Thirdly, transition metals (TM) are liable to dissolve from the Ni-rich NCM cathode materials during battery charge-discharge cycles. The dissolution of transition metal ions from the Ni-rich cathode into the electrolyte is an inevitable process, resulting in fast capacity degradation due to the loss of Li-ion insertion sites in the host structure. This process accelerates at elevated temperatures and high operating voltages.

Therefore, despite the higher binding energy of certain functional groups like carboxylic acid, sulfonic acid, and amide with Co²⁺, Mn²⁺, and Ni²⁺ compared to PVDF, there remains a need for new binder materials and formulations that offer improved chemical stability and effectively address these obstacles. The present invention fulfills this need.

### SUMMARY OF THE INVENTION

It is an objective of the present invention to provide a lithium-ion battery with highly stable electrodes to solve the aforementioned technical problems.

In accordance with a first aspect of the present invention, a lithium-ion battery is provided. The lithium-ion battery includes:
a cathode including one or more nickel-rich ternary cathode materials selected from the materials having the following formula: LiNiₓMn_{y}Co_{z}O₂ or LiNiₓAl_{y}Co_{z}O₂, one or more conductive agents and a gel-free binder, wherein the sum of x, y and z equals 1, and x is greater than or equal to 0.8;
an anode including one or more materials selected from the group consisting of silicon, silicon oxide, carbon nanotubes, lithium metal, graphene, and graphite;
at least one porous polymer separator having a porosity from approximately 30% to 90%; and
an electrolyte.

In accordance with one embodiment of the present invention, the gel-free binder is a modified PVDF grafted with one or more monomers wherein the monomers comprise at least one unsaturated carbon-carbon double bond and one or more functional groups, such that the modified PVDF is prevented from defluorination and crosslinking when exposed to the nickel-rich cathode materials.

In accordance with one embodiment of the present invention, the functional groups are selected from the group consisting of acrylic acid group, methacrylic acid group, phosphate group, polyethylene oxide group, sulfonate group, sulfate group, sulfite group, and cyano group.

In accordance with another embodiment of the present invention, the gel-free binder enables the formation of an inorganic-rich cathode electrolyte interphase (CEI) on the surface of the cathode.

In accordance with another embodiment of the present invention, the gel-free binder has a molecular weight of at least 1.1×10⁶ Dalton.

In accordance with one embodiment of the present invention, the inorganic-rich CEI has a LiF/C—O ratio higher than 1.0 and a LiF/Li₂CO₃ ratio higher than 2.0.

In accordance with one embodiment of the present invention, the modified PVDF grafted with one or more monomers is fabricated by:
activating a PVDF main chain to generate reactive sites thereon; and
grafting the one or more monomers onto the reactive sites.

In accordance with one embodiment of the present invention, the activation of the PVDF main chain is achieved by ozone treatment, plasma treatment, UV treatment or gamma ray radiation treatment.

In accordance with one embodiment of the present invention, the grafting is conducted in a water or water/alcohol solution.

In accordance with one embodiment of the present invention, the grafting is conducted under an inert atmosphere with a reaction temperature ranging from 40° C. to 80° C. and a reaction time of 1 to 50 hrs.

In accordance with one embodiment of the present invention, the gel-free binder enhances the thermal stability of the cathode at temperatures up to 120° C.

In accordance with one embodiment of the present invention, the battery has a specific energy density of at least 300 Wh/kg.

### BRIEF DESCRIPTION OF THE DRAWINGS

Embodiments of the invention are described in more details hereinafter with reference to the drawings, in which:

FIG. 1 depicts the mechanism of the crosslinking of PVDF in base condition which leads to the gelation of the cathode slurry;

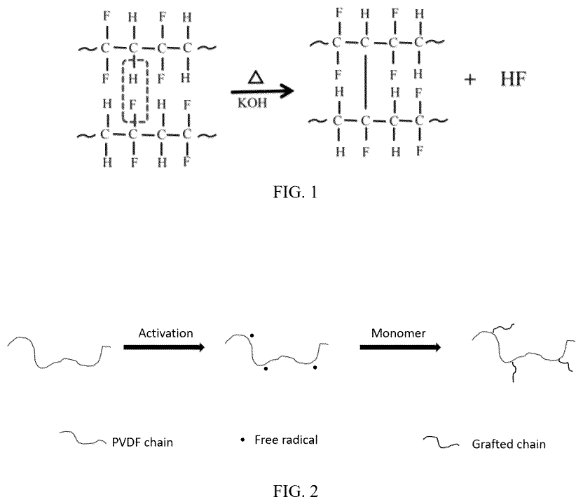

FIG. 2 depicts the process to produce the modified PVDF;

FIG. 3 depicts the FTIR spectrum of HSV900 and modified PVDF;

FIG. 4 depicts the peeling force test between the cathode active materials and aluminum collector using HSV900 and modified PVDF as binders;

FIGS. 5A-5B depict the initial Coulombic Efficiency (CE) (FIG. 5A) and the first cycle charge/discharge curves (FIG. 5B) of the coin cell using HSV900 and modified PVDF as binders in cathode; and

FIG. 6 depicts the C-rate test of the coin cell using HSV900 and modified PVDF as binders in cathode.

### DETAILED DESCRIPTION

In the following description, lithium-ion batteries and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

The binder in a lithium-ion battery electrode serves a specific structural role within the electrode itself. Below is a detailed explanation of the structural relationship among the binder, cathode, and electrolyte.

The cathode is composed of active material particles (e.g., nickel-rich ternary compounds like NCM or NCA), conductive additives (e.g., carbon black), and a binder (e.g., polyvinylidene fluoride, PVDF). The active material is responsible for storing and releasing lithium ions during the charge-discharge cycles. Conductive additives ensure good electrical conductivity throughout the electrode. The binder is a polymer that holds the active material and conductive additives together, providing mechanical integrity and flexibility to the electrode. It ensures that the electrode particles are well-adhered to each other and to the current collector (usually aluminum foil), maintaining the structural integrity of the electrode during repeated cycling.

During the initial charge-discharge cycles, the electrolyte undergoes decomposition at the cathode surface, leading to the formation of the cathode electrolyte interphase (CEI). The CEI is a passivation layer composed of inorganic and organic compounds (e.g., LiF, Li₂CO₃) that form on the surface of the cathode particles. The CEI helps protect the cathode from further electrolyte decomposition and stabilizes the electrode/electrolyte interface.

In summary, the binder is integral to the solid structure of the cathode, maintaining the integrity and stability of the electrode, while the electrolyte facilitates ion transport. The CEI forms at the interface between the cathode material and the electrolyte, playing a crucial role in the overall performance and longevity of the battery.

In accordance with a first aspect of the present invention, a lithium-ion battery is provided. The lithium-ion battery includes several advanced components to enhance performance and stability. Central to the invention is a cathode that includes one or more nickel-rich ternary cathode materials. These materials are selected from those having the formula LiNiₓMn_{y}Co_{z}O₂ or LiNiₓAl_{y}Co_{z}O₂. These nickel-rich compositions are critical as they offer higher energy densities and better performance characteristics compared to traditional cathode materials. The sum of x, y, and z in these formulas equals 1, with x being greater than or equal to 0.8, ensuring a high nickel content that significantly boosts the specific capacity of the cathode.

The cathode also contains one or more conductive agents to improve electrical conductivity and a gel-free binder. As used herein, a gel is a semi-solid material that can range in consistency from soft and weak to hard and tough. Gels are characterized as a largely dilute crosslinked system that does not flow when in a steady state, although the liquid component can still move through the network. Gels are primarily composed of liquid by mass but exhibit solid-like behavior due to a three-dimensional crosslinked network within the liquid. This crosslinking provides the gel with structural and adhesive properties, making it a dispersion of liquid molecules within a solid framework. “Gel-free” binders, do not exhibit this crosslinking behavior, making their rheological properties predictable, permitting cathode formation by automatic machine-based casting techniques.

In order to produce a cathode with a gel-free binder, the present invention uses a modified polyvinylidene fluoride. This modified binder uses polyvinylidene fluoride (PVDF) grafted with one or more monomers. The innovative use of a gel-free binder addresses common issues in battery manufacturing, such as slurry stability and electrode performance. The monomers grafted onto the PVDF include at least one unsaturated carbon-carbon double bond and various functional groups, such that the modified PVDF is prevented from defluorination and crosslinking when exposed to the nickel-rich cathode materials. The functional groups, including acrylic acid, methacrylic acid, phosphate, polyethylene oxide, sulfonate, sulfate, sulfite, and cyano groups, enhance the binding properties and chemical stability of the binder.

In some embodiments, the examples of the monomer include, but are not limited to, acrylic acid (AA), methacrylic acid (MAA), 2-acrylamido-2-methylpropane sulfonic acid (AMPS), 2-hydroxyethyl methacrylate phosphate (HEMA phosphate), acrylonitrile, 2-(Trifluoromethyl) acrylic acid (TFMAA), 3-sulfopropyl methacrylate potassium salt and polyethylene glycol monomethyl ether methacrylate.

The anode of the battery comprises one or more materials selected from silicon, silicon oxide, carbon nanotubes, lithium metal, graphene, and graphite. These materials are chosen for their high capacity and stability, which are essential for improving the overall performance of the battery. A porous polymer separator with a porosity ranging from approximately 30% to 90% is included to physically separate the cathode and anode while allowing ionic conductivity. The separator material contributes to the safety and efficiency of the battery.

The electrolyte, which is critical for ion transport between the anode and cathode, completes the basic structure of the lithium-ion battery. The gel-free binder, apart from providing mechanical support, plays a crucial role in enabling the formation of an inorganic-rich cathode electrolyte interphase (CEI) on the surface of the cathode. This CEI layer significantly enhances the battery's stability and performance. Specifically, the inorganic-rich CEI is characterized by a LiF/C—O ratio higher than 1.0 and a LiF/Li₂CO₃ ratio higher than 2.0, indicating a robust and stable interphase.

The molecular weight of the gel-free binder is at least 1.1×10⁶ Daltons, ensuring adequate mechanical strength and flexibility. The process of grafting monomers onto the PVDF main chain involves activating the PVDF to generate reactive sites. This activation can be achieved through methods such as ozone treatment, plasma treatment, UV treatment, or gamma ray radiation treatment. Once activated, the monomers are grafted onto the reactive sites in a water or water/alcohol solution under an inert atmosphere, with reaction temperatures ranging from 40° C. to 80° C. and reaction times from 1 to 50 hours.

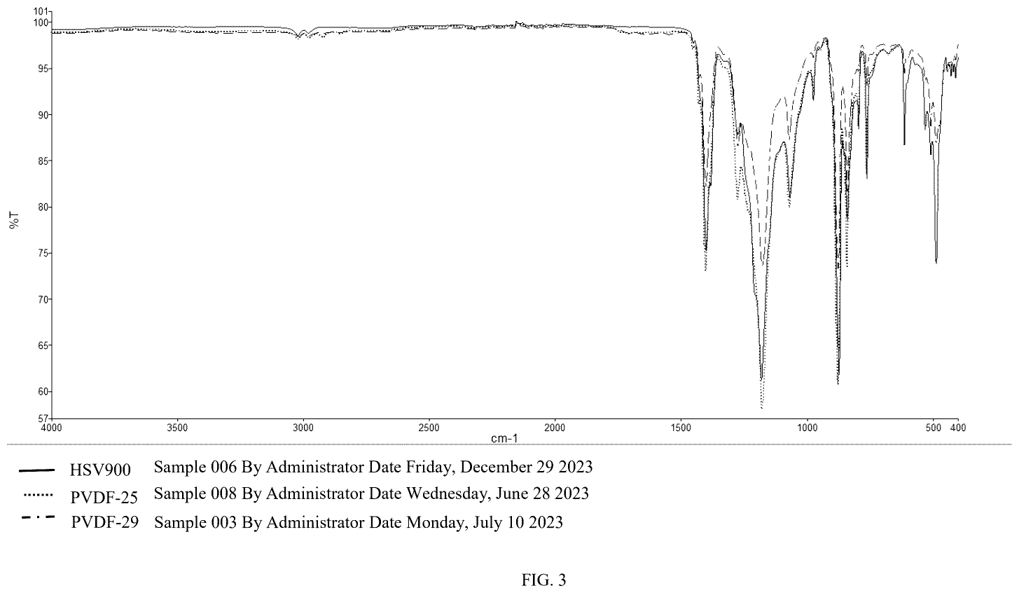

As shown in FIG. 2, the process of grafting monomers onto PVDF main chain is illustrated. The process includes two steps, in which the first step is to activate the PVDF to produce active sites, e.g. free radicals, on the PVDF main chain by ozone treatment, plasma treatment, UV treatment or gamma ray radiation treatment. The second step is to graft monomers onto the active sites of the activated PVDF as side chain by free radical polymerization. The chemical structure of the monomers contains unsaturated carbon-carbon double bond which can react with the active site of the activated PVDF via free radical polymerization, and functional group which is beneficial to the binder performance.

In some embodiments, the grafting process is performed through free radical polymerization and must be conducted under an inert atmosphere, such as nitrogen (N₂) or argon. The reaction is preferably carried out in an aqueous or aqueous/alcohol solution, depending on the solubility of the monomers in water or the water/alcohol mixture. The preferred concentration of the monomers in the solution ranges from 50 to 500 g/L, with a more preferred range of 100 to 300 g/L. The reaction temperature is ideally between 40° C. and 100° C., with a more optimal range of 40° C. to 80° C. The preferred reaction time is between 1 and 50 hours, with a more preferred duration of 4 to 24 hours. After completing of the reaction, unreacted monomers are removed by washing with water or water/alcohol for several times, and the modified PVDF may be dried at 60-100° C.

Additionally, the gel-free binder enhances the thermal stability of the cathode, allowing it to operate effectively at temperatures up to 120° C. This thermal stability is crucial for maintaining battery performance and safety under various operating conditions. Furthermore, the lithium-ion battery described here achieves a specific energy density of at least 300 Wh/kg, making it highly efficient for applications requiring high energy density, such as electric vehicles and portable electronic devices.

Overall, the detailed construction and formulation of this lithium-ion battery provide significant advancements in energy density, thermal stability, and manufacturing reliability, addressing many of the current limitations in battery technology.

### EXAMPLES

### Example 1. Fabrication of the Modified PVDF

To prepare the modified PVDF (PVDF-25), 3 grams of HSV900, a PVDF with a molecular weight of approximately 900,000 Dalton, is treated with ozone for 60 minutes at room temperature. The oxygen gas flow rate is set to 5 L/min, and the generated ozone concentration is approximately 60 g/m³. After the ozone treatment, the HSV900 is placed into a 250 ml three-neck flask equipped with a thermocouple and nitrogen gas inlet. Subsequently, 10 grams of 2-(Trifluoromethyl)acrylic acid (TFMAA) and 80 grams of deionized water are added to the flask. Nitrogen gas is bubbled through the solution containing the HSV900 for 40 minutes to remove any remaining oxygen or ozone. The temperature of the solution is then increased to 80° C. to facilitate the grafting process under nitrogen protection. After 6 hours, the solution is cooled to room temperature, and the modified PVDF (PVDF-25) is recovered by filtration and washed with a large amount of deionized water at least three times to remove any unreacted TFMAA. The PVDF-25 is then dried at 80° C. for 10 hours.

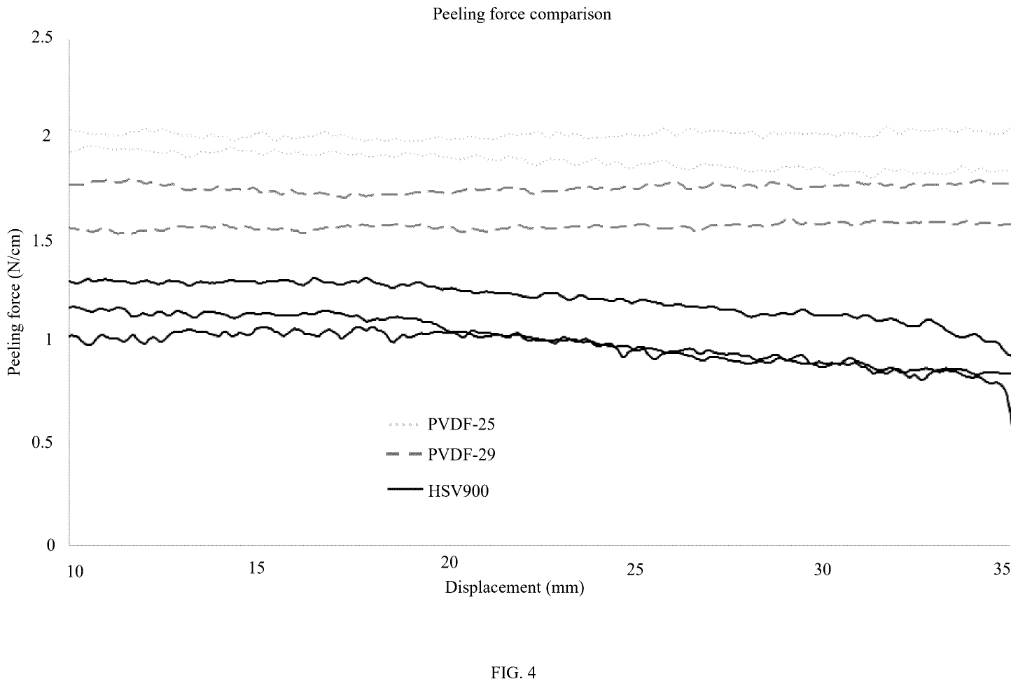

Fourier-transform infrared (FTIR) spectroscopy measurements are performed on both HSV900 and PVDF-25 (FIG. 3). In the spectrum of HSV900, no peak is observed at 1710 cm⁻¹. In contrast, a small peak at 1710 cm⁻¹ is present in the spectrum of PVDF-25, attributed to the carbonyl group of the TFMAA, confirming the successful grafting of TFMAA onto the PVDF.

High-temperature gel permeation chromatography (GPC) tests for PVDF are conducted at 80° C. using an Agilent PL-GPC120 GPC tester equipped with a PLgel 10 μm MIXED-B 300×7.5 mm GPC column. DMF solvent is used to dissolve and carry the PVDF through the column at a flow rate of 1 mL/min. Polystyrene (PS) is used as the standard sample for GPC calibration. Both HSV900 and PVDF-25 are tested using this GPC method. The molecular weight of HSV900 is found to be in the range of 800,000 to 1,500,000 Dalton, whereas PVDF-25 has a molecular weight range of 1,100,000 to 1,650,000 Dalton, representing an increase of approximately 8-50% after the grafting modification. The results are shown in Table 1.

TABLE 1
Weight average molecular weight result tested by high temperature GPC along
with the ratio of the molecular weight of PVDF-25 to pristine PVDF HSV900

| | Weight average molecular weight | | | |
|---|---|---|---|---|
| Pristine | 1079602 | 1079602 | 1254942 | 1254942 |
| PVDF HSV900 | | | | |
| Modified PVDF-25 | 1167710 | 1612788 | 1467138 | 1454648 |
| (different batches) | | | | |
| Ratio | 1.081612 | 1.493873 | 1.169088 | 1.159136 |
| (Mw_{PVDF-25}/Mw_{HSV900}) | | | | |

Additionally, another modified PVDF grafted with a different monomer is introduced. Briefly, 3 grams of HSV900, a PVDF with a molecular weight of approximately 900,000 Dalton, is treated with oxygen plasma for 9 minutes at room temperature. The plasma-treated HSV900 is then placed into a 250 ml three-neck flask equipped with a thermocouple and nitrogen gas inlet. Subsequently, 12 grams of 3-sulfopropyl methacrylate potassium salt and 80 grams of deionized water are added to the flask. Nitrogen gas is bubbled through the solution containing the HSV900 for 40 minutes to remove any remaining oxygen. The temperature of the solution is then increased to 70° C. for the grafting process under nitrogen protection. After 16 hours, the solution is cooled to room temperature, and the treated PVDF is recovered by filtration and washed with a large amount of deionized water at least three times to remove any unreacted monomer. The treated PVDF is then immersed in a large amount of 1M sulfuric acid for 24 hours to convert the potassium sulfonate salt to sulfonic acid. Afterward, the PVDF is washed with a large amount of deionized water at least three times and dried at 80° C. for 16 hours. The obtained PVDF is coded as PVDF-29.

Both HSV900 and PVDF-29 undergo FTIR measurements (FIG. 3). In the spectrum of HSV900, no peak is observed at 1710 cm⁻¹. However, a small peak at 1710 cm⁻¹ appears in the spectrum of PVDF-29, which is attributed to the carbonyl group of the sulfonic acid, confirming the successful grafting of the monomer onto the PVDF.

### Example 2. Preparation of the Cathode Slurry

The cathode slurry is prepared by combining 0.6 grams of HSV900 or PVDF-25, 0.5 grams of Super P conductive material, 8.9 grams of NCM811, and 13 grams of NMP. To accelerate the gelation process, 500 ppm of water is additionally added to the slurry. The slurry is placed into a sealed container and stored at room temperature for a certain period. After ten days, the slurry containing HSV900 as the binder is gelled, whereas the slurry with PVDF-25 as the binder maintained good flowability.

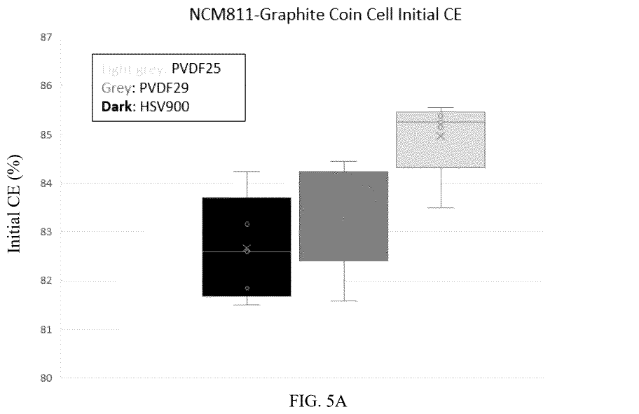

The cathode slurry composed of 0.6 grams of HSV900 or PVDF-25, 0.5 grams of Super P conductive material, 8.9 grams of NCM811, and 13 grams of NMP is coated onto an aluminum collector, dried, and calendared to prepare the cathode electrode. The peeling force between the cathode materials and the aluminum current collector is tested, and the results are shown in FIG. 4. The data indicates that the binding force is significantly improved when using PVDF-25 as the binder compared to HSV900.

Additionally, PVDF-29 is tested in the preparation of a cathode slurry. The slurry is prepared by combining 0.6 grams of PVDF-29, 0.5 grams of Super P conductive material, 8.9 grams of NCM811, and 13 grams of NMP. This slurry is coated onto an aluminum collector, dried, and calendared to prepare the cathode electrode. The peeling force between the cathode materials and the aluminum collector is tested, and the results are shown in FIG. 4. The results demonstrate that the binding force is significantly improved when using PVDF-29 as the binder compared to HSV900.

Collectively, using PVDF-25 and PVDF-29 as binders in preparing cathode slurry offers significant advantages. PVDF-25 maintains good flowability of the cathode slurry over time, preventing gelation, unlike HSV900, which tends to gel after a period. Additionally, both PVDF-25 and PVDF-29 provide a stronger binding force between the cathode materials and the aluminum current collector, enhancing the mechanical stability of the electrode. The modified PVDF binders also improve adhesion properties, contributing to better electrode integrity and overall performance. These improvements result in more reliable and efficient lithium-ion battery electrodes.

For instance, the ratios of LiF/C—O and LiF/Li₂CO₃ are investigated using X-ray photoelectron spectroscopy (XPS) analysis. The components at both the surface and 20 nm below the surface in the cathodes with the binder PVDF-25-8 compared to HSV900 are evaluated, and the results are presented in Table 2. The ratio of stable LiF (derived from the XPS peak at 685 eV) to organic components (from the C—O peak at 287.3 eV by XPS) and the ratio of LiF to unstable lithium carbonate (derived from the XPS peak at 532 eV) indicate the degree of stability of the CEI formed on the surface of the cathode. A LiF/C—O ratio larger than 1.0 and a LiF/Li₂CO₃ ratio larger than 2.0 are preferred, as they signify the formation of a stable CEI on the surface of the cathode.

TABLE 2
Calculated results for the peak ratios of LiF/C—O and
LiF/Li₂CO₃ obtained from XPS analysis on the
cathodes with various types of binder

| | HSV900 | PVDF25-8 | Solef5130 |
|---|---|---|---|
| Peak ratio (surface) | | | |
| LiF over C—O | 0.143 | 1.643 | 1.908 |
| LiF over Li₂CO₃ | 0.126 | 2.142 | 1.499 |
| Peak ratio (etching 20 nm) | | | |
| LiF over C—O | 0.127 | 1.493 | 1.501 |
| LiF over Li₂CO₃ | 0.167 | 2.332 | 1.682 |

### Example 3. Evaluating the Performances of the Batteries Utilizing HSV900, PVDF-25 or PVDF-29 as Binders

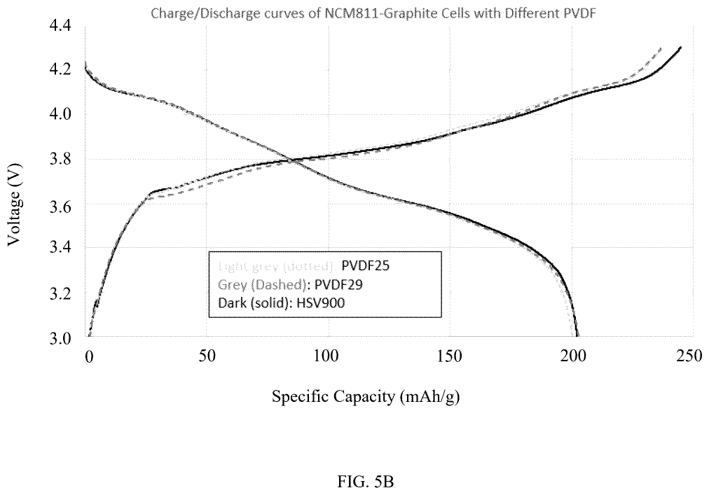

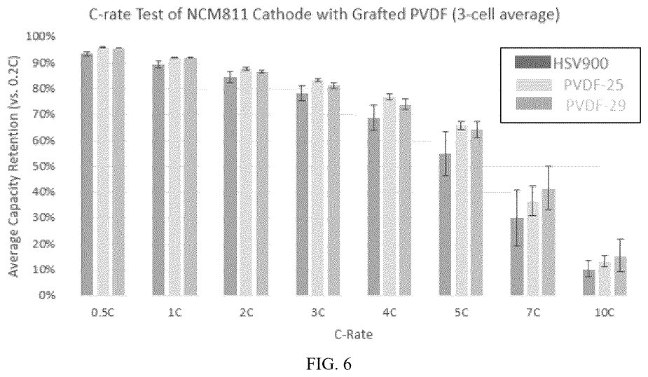

The cathodes using HSV900 and PVDF-25 as binders are utilized to fabricate coin cell batteries with graphite as the anode. The Coulombic Efficiency (CE) and the charge/discharge curve of the first charge/discharge cycle are measured, as shown in FIGS. 5A-5B. It is observed that the battery using PVDF-25 as the cathode binder exhibits improved CE compared to the battery using HSV900 as the cathode binder. Furthermore, in the C-rate test, the coin cell using PVDF-25 as the binder in the cathode demonstrates better capacity retention than the cell using HSV900, particularly at high C rates, such as above 5C (FIG. 6).

Similarly, cathodes using PVDF-29 as binders are used to fabricate coin cell batteries with graphite as the anode. The CE and the charge/discharge curve of the first charge/discharge cycle are measured, and the results are presented in FIGS. 5A-5B. The battery using PVDF-29 as the cathode binder shows improved CE compared to the battery using HSV900 as the cathode binder. Additionally, in the C-rate test, the coin cell using PVDF-29 as the binder in the cathode displays better capacity retention than the cell using HSV900, especially at high C rates, such as above 5C (FIG. 6).

In summary, the use of PVDF-25 and PVDF-29 as binders in the preparation of cathodes for lithium-ion batteries offers significant advantages. Both PVDF-25 and PVDF-29 improve the CE of the batteries compared to HSV900. Additionally, these modified PVDF binders enhance capacity retention, particularly under high C-rate conditions. This demonstrates that PVDF-25 and PVDF-29 are superior binder materials for improving the performance and efficiency of lithium-ion batteries.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A lithium-ion battery, comprising:
a cathode comprising one or more nickel-rich ternary cathode materials selected from the materials having the following formula: LiNiₓMn_{y}Co_{z}O₂ or LiNiₓAl_{y}Co_{z}O₂, one or more conductive agents and a gel-free binder, wherein the sum of x, y and z equals 1, and x is greater than or equal to 0.8;
an anode including one or more materials selected from the group consisting of silicon, silicon oxide, carbon nanotubes, lithium metal, graphene, and graphite;
at least one porous polymer separator having a porosity from approximately 30% to 90%; and
an electrolyte;
wherein the gel-free binder is a modified polyvinylidene fluoride (PVDF) grafted with one or more monomers wherein the monomers comprise at least one unsaturated carbon-carbon double bond and one or more functional groups, such that the modified PVDF is prevented from defluorination and crosslinking when exposed to the nickel-rich cathode materials;
wherein the functional groups are selected from the group consisting of acrylic acid group, methacrylic acid group, phosphate group, polyethylene oxide group, sulfonate group, sulfate group, sulfite group, and cyano group.

2. The lithium-ion battery of claim 1, wherein the gel-free binder enables the formation of an inorganic-rich cathode electrolyte interphase (CEI) on the surface of the cathode.

3. The lithium-ion battery of claim 1, wherein the gel-free binder has a molecular weight of at least 1.1×10⁶ Dalton.

4. The lithium-ion battery of claim 2, wherein the inorganic-rich CEI has a LiF/C—O ratio higher than 1.0 and a LiF/Li₂CO₃ ratio higher than 2.0.

5. The lithium-ion battery of claim 1, wherein the modified PVDF grafted with one or more monomers is fabricated by:
activating a PVDF main chain to generate reactive sites thereon; and
grafting the one or more monomers onto the reactive sites.

6. The lithium-ion battery of claim 5, wherein the activation of the PVDF main chain is achieved by ozone treatment, plasma treatment, UV treatment or gamma ray radiation treatment.

7. The lithium-ion battery of claim 5, wherein the grafting is conducted in a water or water/alcohol solution.

8. The lithium-ion battery of claim 7, wherein the grafting is conducted under an inert atmosphere with a reaction temperature ranging from 40° C. to 80° C. and a reaction time of 1 to 50 hrs.

9. The lithium-ion battery of claim 1, wherein the gel-free binder enhances the thermal stability of the cathode at temperatures up to 120° C.

10. The lithium-ion battery of claim 1, wherein the battery has a specific energy density of at least 300 Wh/kg.
